(19) United States
(12) Patent Application Publication
(10) Pub. No.: US 2010/0207347 A1
(43) Pub. Date: Aug. 19, 2010

(54) SPRING STRUT BEARING

(75) Inventor: Kyung rok Han, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/678,506

(22) PCT Filed: Oct. 9, 2008
(86) PCT No.: PCT/DE08/50030

§ 371 Date: Mar. 17, 2010

(30) Foreign Application Priority Data
Oct. 10, 2007 (DE) 10 2007 048 784.5

(51) Int. Cl. B60G 13/08

(52) U.S. Cl. 280/124.157

(57) ABSTRACT

A suspension strut bearing for supporting the top end of a suspension strut in a motor vehicle. The suspension strut comprises an inner part (1) for fastening the suspension strut bearing (2) to the top end of the suspension strut, a casing (4) for connecting the suspension strut bearing (2) to the motor vehicle, a working spring (3) formed by at least one elastomeric body for a vibration-damping connection between the inner part (1) and the casing (4), at least two chambers (5, 6) filled with a fluid, and a channel (7) forming a fluid-conducting connection between the two chambers (5, 6). The channel (7) is equipped with a valve switching unit (8) that regulates the flow between the two chambers (5, 6).

This application is a National Stage completion of PCT/DE2008/050030 filed Oct. 9, 2008, which claims priority from German patent application serial no. 10 2007 048 784.5.

### FIELD OF THE INVENTION

This invention relates to a suspension strut bearing.

### BACKGROUND OF THE INVENTION

A suspension strut bearing, for vibration-damping support of the top end of a suspension strut in a motor vehicle, is disclosed in DE 10 2004 051 112 B3, for example. This known design has a casing that enables the suspension strut bearing to be installed into a motor vehicle. An inner part is used to connect the top end of the suspension strut to the suspension strut bearing. The inner part in turn is accommodated in a working spring formed by at least one elastomeric body. In order to accommodate the inner part in a vibration-damping manner, the elastomeric body has a constant force-displacement characteristic and/or torsional moment-angle characteristic, which depends on the material used. These characteristics of the elastomeric part are determined with great expenditure in road tests. When doing this, the vehicle has to meet the imposed requirements both with regard to driving comfort and driving safety. The support of the top end of a suspension strut in a motor vehicle is of critical importance for the entire wheel suspension of a motor vehicle. It is a drawback of the existing designs that a change of damping is possible only by replacing the entire suspension strut bearing. No desirable adaptation to the specific driving behavior of the driver or to changing road conditions can be accomplished in this way.

DE 10 2004 032 470 A1 also discloses a support of the top end of a suspension strut by means of a suspension strut bearing present on each wheel of the vehicle, wherein an electromagnet is used to set the height level of the vehicle wheel. In this case, the inner part of the suspension strut bearing is mounted as a mobile armature between two coils surrounding the armature. In this embodiment, the motor vehicle as a whole can be lowered or raised. Changing the bearing characteristic or the damping characteristics of the suspension strut bearing, however, is likewise impossible.

Furthermore, DE 101 53 007 A1 discloses a design for a suspension strut bearing that comprises an inner part to support the top end of a suspension strut. This inner part is embedded in an elastomeric bearing body. The elastomeric body is accommodated with the inner part in a hydraulically adjustable piston. The piston can be displaced, in the axial direction, relative to the bearing center line between an upper and a lower position. In this embodiment, it is possible to raise or lower the motor vehicle. It is likewise not possible to change the bearing characteristics with this variant.

DE 199 51 693 C1 also discloses a suspension strut bearing for supporting the top end of a suspension strut in a motor vehicle. This design has an inner part for fastening the suspension strut bearing to the top end of the suspension strut. The suspension strut bearing is connected to the motor vehicle by way of the casing thereof. An elastomeric body serves to dampen the vibrations caused by the road. This body is designed as a working spring and represents a connection between the inner part and the casing. Suspension strut bearings are additionally equipped with a hydraulic damper, since only rising dynamic rigidities can be achieved with simple elastomeric bearings. This damper has a specific damping characteristic. The suspension strut bearing, disclosed in DE 199 51 693 C1, is equipped with at least two chambers filled with a fluid and a channel for a fluid-conducting connection of the chambers. In a model concept, such a suspension strut bearing links different springs, with one spring being formed by the working spring and the other spring by the hydraulic system, comprising the chambers that are connected to one another by a channel. However, it is a drawback of this embodiment that there is no flexible adaptation to changing road conditions.

### SUMMARY OF THE INVENTION

The problem underlying the invention is to create a suspension strut bearing that has a simple design and, in addition, provides at least two different damping characteristics. The suspension strut bearing should be able to adapt flexibly to changing influences of the road, including those associated with steering motions, and should allow the driver to preset the damping.

A suspension strut bearing for supporting the top end of a suspension strut in a motor vehicle, comprising:
an inner part for fastening the suspension strut bearing to the top end of the suspension strut,
a casing for connecting the suspension strut bearing to the motor vehicle,
a working spring formed by at least one elastomeric body for establishing a vibration-damping connection between the inner part and the casing,
at least two chambers filled with a fluid, and
a channel for a fluid-conducting connection of the chambers was improved, according to the invention, by providing the channel with a valve switching unit regulating the flow rate.

A very simple possibility to regulate the flow through the channel, which is to say the flow rate inside the channel, is provided by the solution according to the invention. The valve switching unit serves the purpose of completely or partially closing off or opening the channel. In this way, when the channel is closed, the vibrations are damped exclusively by the elastomeric body designed as a working spring, while when the channel is opened, the advantages of hydraulic damping can additionally be utilized, depending on the cross-section of the channel available. Cost-intensive methods that are difficult to control, such as those using rheological fluids, for example, can be avoided by the solution according to the invention.

According to a first embodiment of the invention, the valve switching unit has an electromagnet. By connecting the valve switching unit to an electromagnet, the partially mechanical solution can be suitably supplemented with an electromagnet and thus represents an electromagnetic valve or an electromagnetically assisted valve. The electromagnet has the advantage that it enables the channel to be completely or partially opened and closed, with very short switching times. Thus, the damping characteristics of the suspension strut bearing, according to the invention, can be adapted to influences from the road changing at very short time intervals. In the same way, damping can be adapted to any definable values. The chassis can thus be set by the driver, for example, to be oriented to damp toward sportiness or comfort.

Furthermore, a particularly simple embodiment of the solution, according to the invention, is to equip the electromagnet with a coil and an armature moveable in the channel against the force of a spring. The armature is thus integrated directly in the channel. Consequently, no additional components are necessary to regulate the channel cross-section. The direct influencing of the volume flowing through the channel thus obtained leads to a change of the damping characteristics in real time.

It is particularly advantageous if the armature is designed as a piston. The armature corresponding in the structure thereof to a piston leads to a solution which is very easy to manufacture. Thus, the guide and the armature designed as a piston can be configured as rotationally symmetrical components, which also advantageously simplifies sealing them from the surroundings. The spring, which is present in the valve switching unit and against which the armature can be moved, can be used to return the armature to the neutral position thereof.

By designing the armature as a piston, the idea according to the invention is for the piston to be moveable back and forth between the end “channel completely open” and “channel completely closed” positions. The particular advantage of the solution according to the invention, however, is that any arbitrary or necessary intermediate position can be reached and set, so that a partial closure of the channel and with it only a partial reduction of the flow rate of hydraulic fluid between the chambers can be achieved.

In order to implement the previously described possibilities, it is also proposed that the suspension strut bearing has a load-dependent regulator for the coil current of the electromagnetic valve switching unit. In this case, regulation of the coil current, as a function of the oscillations and vibrations acting on the suspension strut bearing and originating from the wheel suspension, is also within the scope of the concept of the invention. Therefore, load-dependent regulation in the context of the invention means, for example, that the intensity of the coil current is regulated as a function of the frequencies introduced into the suspension strut bearing by way of the suspension strut. The vibrations to be damped here represent the disturbances of a control system. By means of adapted electronics suitable for this purpose, signals from the sensors present on the wheel suspension can be used advantageously to control the electromagnet, in order to ensure optimal regulation of the suspension strut bearing.

Active regulation of the suspension strut bearing can be achieved, for example, in that sensors on the vehicle wheels and the steering system capture information in the form of signals, which are collected in suitable processing units and linked, for example, to information on road conditions and/or driving conditions. Optimal damping values for the suspension strut bearing can be determined based the collected information. In addition, the driver can also here preset the damping, for example, to perform a sporty- or comfort-oriented adjustment of the chassis.

Another proposal pursuant to the invention involves fastening the valve switching unit to the outside of the casing of the suspension strut bearing. Thus, the valve switching unit does not otherwise affect the properties of the suspension strut bearing. The suspension strut bearing can be made compact in this way. This is particularly important because in a motor vehicle the available installation space, in the area of the suspension strut bearing, is limited.

In order to protect the valve switching unit against mechanical damage, according to an advantageous embodiment of the invention, the valve switching unit is fastened to the suspension strut bearing in a manner that offers protection by a cap against mechanical damage. This cap, in turn, can be protected against external effects by buffer elements made of elastomeric materials, such as rubber.

Overall the suspension strut bearing, according to the invention, has considerable advantages with regard to noise development, vibration damping, and the necessary hardness. At least two different damping characteristics can be achieved with the suspension strut bearing. These are provided at least in an axial and/or radial direction. However, damping that originates from rotational motions of the piston rod can also be achieved. This represents another advantage over existing solutions. It is possible thereby to provide a wheel suspension for a motor vehicle which can be flexibly adapted to the vibrations originating from the road and the damping characteristics of which can be varied. Supporting electronic sensor units or sensors can be used for this purpose. A particularly advantageous combination is the use of electronically controllable shock absorbers or electronically controllable steering systems. The damping characteristics can be optimized, in this way, in any driving condition.

Another special advantage consists of the direct effect of steering on the characteristic of the suspension strut bearing. Thus, differentiation between a high and a low vehicle speed and the steering actions required to do so is enabled. In addition, the advantages of electromagnetically switchable valves are used for the invention. They have a very short response time, of less than 0.1 second, and an exceptional service life.

### BRIEF DESCRIPTION OF THE DRAWINGS

The invention will be described below in further detail with reference to the drawings. The embodiments shown do not represent any limitation to the illustrated variants, but serve only to explain the principle of the invention. Identical or nearly identical components are denoted with the same reference numerals. In order to be able to illustrate the principle of operation according to the invention, only greatly simplified sketches are shown in the figures, in which the components not essential for the invention have been omitted. However, this does not mean that such components are not present in a solution according to the invention.

Shown are:

FIG. 1: A very simplified schematic illustration of a suspension strut bearing according to the invention,

FIG. 2: The valve switching unit in a simplified schematic illustration in the “channel completely open” switched position,

FIG. 3: The valve switching unit in a very simplified schematic illustration in the “channel completely closed” switched position,

FIG. 4: A sectional illustration of the top end of a suspension strut having a suspension strut bearing according to the invention fastened thereto.

### DETAILED DESCRIPTION OF THE PREFERRED EMBODIMENTS

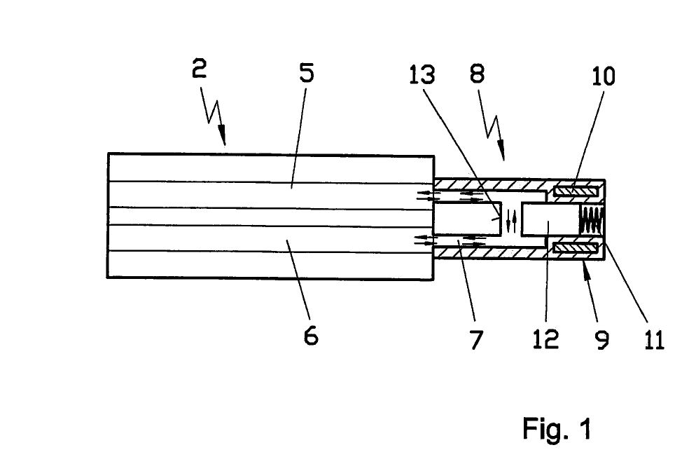

In the illustration of FIG. 1, the suspension strut bearing 2 is shown schematically greatly simplified and only by way of illustration. It has two chambers 5 and 6 that are connected with one another by a fluid-conducting channel 7. Channel 7 passes from the chambers 5, 6 into the valve switching unit, labeled 8 as a whole. The valve switching unit 8 has an armature 12, which is configured as a piston and can be moved against the force of a spring 11. The armature 12 projects into the channel 7. The armature 12, the spring 11, and the coil 10 surrounding the armature 12 together form an electromagnet 9. As is apparent from FIG. 1, the valve switching unit 8 is attached to the outside of casing 4 of the suspension strut bearing 2. A contact area 13 is present opposite of the armature 12, designed as a piston, a corresponding surface of the armature 12 comes to rest against said contact surface when the channel is closed.

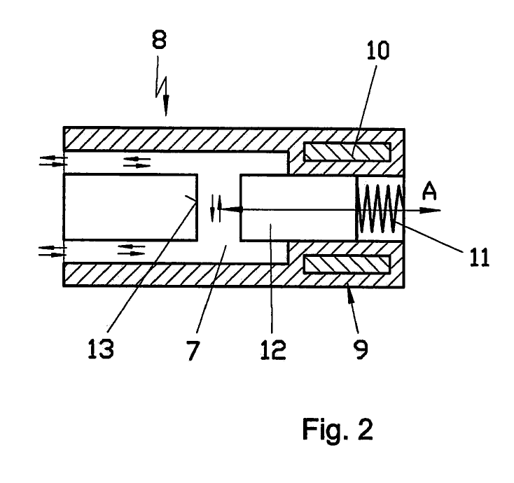

The very simplified schematic illustration of the valve switching unit 8, in detail in FIG. 2, shows an open position of the armature 12 so that the exchange of fluid, between the chambers 5 and 6, can occur unhindered through the fluid-conducting channel 7. The suspension strut bearing, according to the invention in this switched position of the armature 12, has both damping by the working spring 3, designed as an elastomeric body, and hydraulic damping, to reduce the vibrations originating from the road. In FIG. 2, possible flow directions of the fluid in the channel 7 are shown, only by way of illustration, by the arrows. The mobility of the piston-shaped armature 12 is also indicated by a double-headed arrow “A”. Here, the helical spring 11 is shown in a compressed form.

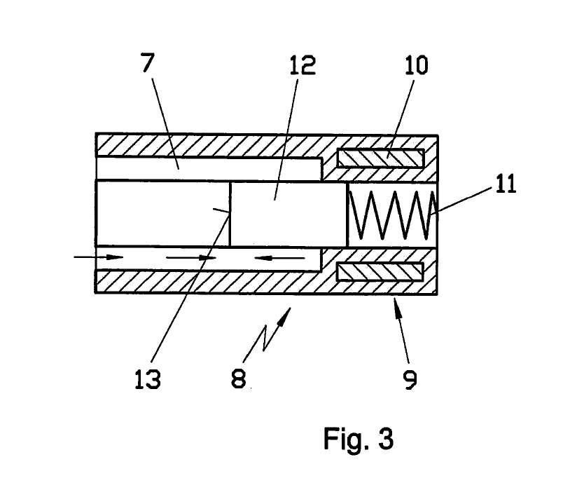

FIG. 3 shows, in contrast to the illustration in FIG. 2, a switched position in which the channel 7 is completely closed. The closure is achieved by the armature 12 designed as a piston. The face of the armature 12 is in direct contact with the corresponding contact area 13 of the valve switching unit 8. In this position of the armature 12, the spring 11 is completely decompressed. The change of the switched state of the armature 12, and with it the effect on the cross-section of the channel 7, is brought about by suitable energizing of the coil 10 of the electromagnet 9. In the switched position of the valve switching unit 8 shown in FIG. 3, damping in the suspension strut bearing is achieved exclusively by the working spring 3 designed as an elastomeric body.

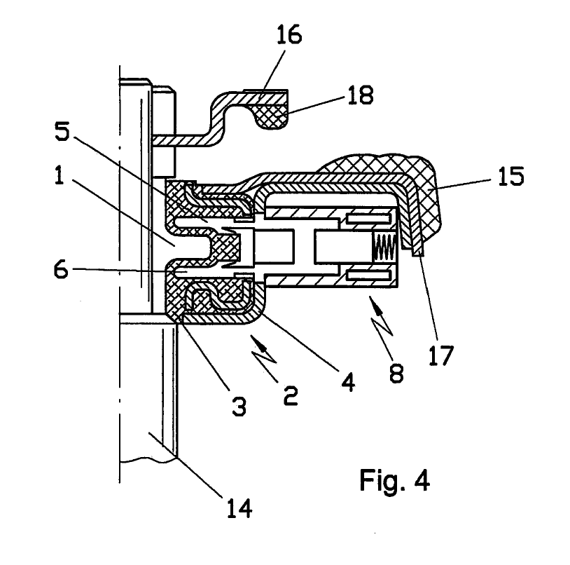

For reasons of clarity, FIG. 4 shows a simplified representation of one possibility for the installation of a suspension strut bearing 2, according to the invention, in a suspension strut. In this case, the top end of the suspension strut, which here is designed as a piston rod 14, has a taper. The inner part 1 of the suspension strut bearing 2 is placed on this tapered dome-like area of the piston rod 14. This inner part 1, approximately near the center thereof, has an annular collar. Chambers 5 and 6 are provided respectively above and below this annular collar of the inner part 1. The chambers 5 and 6 are connected to one another by the channel 7 in a fluid-conducting manner, in the manner described above. The chambers 5 and 6 in this case are integrated in the working spring 3, which here consists of an elastomeric body.

Individual metallic reinforcing inserts in the elastomeric body are of subordinate importance for the invention and are therefore not shown in detail. The suspension strut bearing 2 comprises the valve switching unit 8 projecting laterally, which is present on the outside of the casing 4 of the suspension strut bearing 2. Furthermore, a strut mount 16 is present which has a buffer 18 made of an elastomer and is fastened by nuts to the piston rod 14. In order to offer protection against mechanical stresses, the shown embodiment of the suspension strut bearing has a cap 17 that covers at least the region of the valve switching unit 8. A rubber buffer 15 is provided above the cap 17 and keeps mechanical shocks away from the components below it.

### LIST OF REFERENCE NUMERALS

1 Inner part
2 Suspension strut bearing
3 Working spring (elastomeric body)
4 Casing
5 Chamber
6 Chamber
7 Channel
8 Valve switching unit
9 Electromagnet
10 Coil
11 Spring
12 Armature
13 Contact area
14 Piston rod
15 Rubber buffer
16 Strut mount
17 Cap
18 Buffer

1-8. (canceled)

9. A suspension strut bearing, for supporting the top end of a suspension strut in a motor vehicle, comprising:
an inner part (1) for fastening the suspension strut bearing (2) to a top end of the suspension strut,
a casing (4) for connecting the suspension strut bearing (2) to the motor vehicle,
a working spring (3), formed by at least one elastomeric body (3), for a vibration-damping connection between the inner part (1) and the casing (4),
at least two chambers (5, 6) filled with a fluid, and
a channel (7) in fluid-conducting connection with the at least two chambers (5, 6),
wherein the channel (7) has a valve switching unit (8) regulating the flow.

10. The suspension strut bearing according to claim 9, wherein the valve switching unit (8) has an electromagnet (9).

11. The suspension strut bearing according to claim 10, wherein the electromagnet (9) has a coil (10) and an armature (12) moveable in the channel (7) against the force of a spring (11).

12. The suspension strut bearing according to claim 11, wherein the armature (12) comprises a piston.

13. The suspension strut bearing according to claim 11, wherein the armature (12) is a piston which is moveable back and forth between two a channel completely open position and a channel completely closed position.

14. The suspension strut bearing according to claim 11, wherein the suspension strut bearing has a load-dependent regulator for the coil current.

15. The suspension strut bearing according to claim 9, wherein the valve switching unit (8) is fastened to an outside of the casing (4) of the suspension strut bearing (2).

16. The suspension strut bearing according to claim 9, wherein the valve switching unit (8) is fastened to the suspension strut bearing in a manner that offers protection by a cap (17) against mechanical damage.
